(19) United States
(12) Patent Application Publication
(10) Pub. No.: US 2019/0228683 A1
(43) Pub. Date: Jul. 25, 2019

(54) SELF-ADHESIVE LABEL FOR A TUBE

(71) Applicant: Patrick GONTARD, Geneve (CH)

(72) Inventor: Patrick GONTARD, Geneve (CH)

(21) Appl. No.: 16/306,793

(22) PCT Filed: Jun. 2, 2016
(86) PCT No.: PCT/EP2016/062562

§ 371 Date: Dec. 3, 2018

(51) Int. Cl. G09F 3/00; G09F 3/10; B01L 3/00

(52) U.S. Cl. CPC G09F 3/0295; G09F 3/10; B01L 3/5453; G09F 2003/0269; B01L 2300/042; B01L 2300/126; B01L 2300/021

(57) ABSTRACT

Self-adhesive label (20) for a tube (10), said label (20) being substantially rectangular and having bonding means on the inner surface thereof and identification means (25) on the upper surface thereof, said label (20) having on each longitudinal edge intermittent cuts (26) extending longitudinally along said longitudinal edges.

The present invention concerns a self-adhesive label for tubes, in particular for laboratory test tubes.

Test tubes provided with self-adhesive labels are well known. They generally comprise a cylindrical portion intended to receive a self-adhesive label, notably for purposes of identifying said tube and/or the contents thereof.

A disadvantage with these prior art devices is the danger that, once affixed, the longitudinal edges of these labels can become detached, increasing the risk that the label could be torn off, thus making it impossible to identify the tube.

The present invention aims to provide a self-adhesive label for tubes which does not reproduce the above-mentioned disadvantages.

The present invention also aims to provide a self-adhesive label for tubes which provides improved bonding to a tube, notably a test tube.

The present invention also aims to provide a self-adhesive label for tubes which is simple and inexpensive to manufacture and assemble.

The present invention therefore relates to a self-adhesive label for tubes, said label being substantially rectangular and comprising bonding means on the inner surface thereof and identification means on the upper surface thereof, said label comprising on each longitudinal edge intermittent cuts extending longitudinally along said longitudinal edges.

Advantageously, said intermittent cuts are evenly distributed and extend substantially over the totality of each longitudinal edge of the label.

Advantageously, said intermittent cuts are made in the form of slits separated by bridges of material.

Advantageously, the length of the slits is comprised between 1 and 3 mm, advantageously between 1.5 and 2.5 mm, and the length of the bridges of material is comprised between 0.1 and 1 mm, advantageously between 0.5 and 0.7 mm.

Advantageously, the length of the slits is 1.9 mm and the length of the bridges of material is 0.6 mm.

Advantageously, each longitudinal edge of the label comprises several series of intermittent cuts spaced transversely.

Advantageously, said series of intermittent cuts are evenly spaced in the transverse direction.

Advantageously, the length between the longitudinal edge of the label and the first series of intermittent cuts is 1 mm, the length between the first series of intermittent cuts and the second series of intermittent cuts is 1 mm, and the length between the second series of intermittent cuts and the third series of intermittent cuts is 1 mm.

Advantageously, the length of the label is comprised between 35 and 44 mm and the width of the label is comprised between 18 and 29 mm.

Advantageously, said length is 44 mm, said width is 25 mm, and the corners of the label are curved with a radius of curvature R of 1 mm.

The present invention also relates to a tube comprising a cylinder provided on one end with an opening and closed on the other end by an end portion, preferably rounded, a label as described above being affixed to said cylinder.

Advantageously, said tube is a laboratory test tube.

Advantageously, the volume of the tube is comprised between 1.8 and 10 ml, and the length of the tube is comprised between 66 and 100 mm.

These and other features and advantages will become clearer during the following detailed description, with reference to the attached drawings, given by way of non-limiting examples, and wherein:

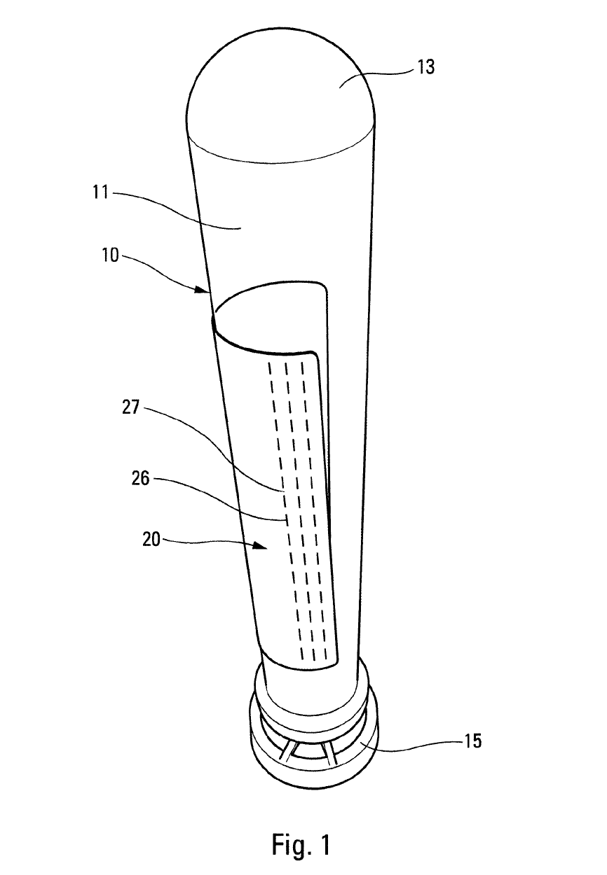

FIG. 1 is a schematic perspective view of a test tube provided with a self-adhesive label according to an advantageous embodiment of the present invention,

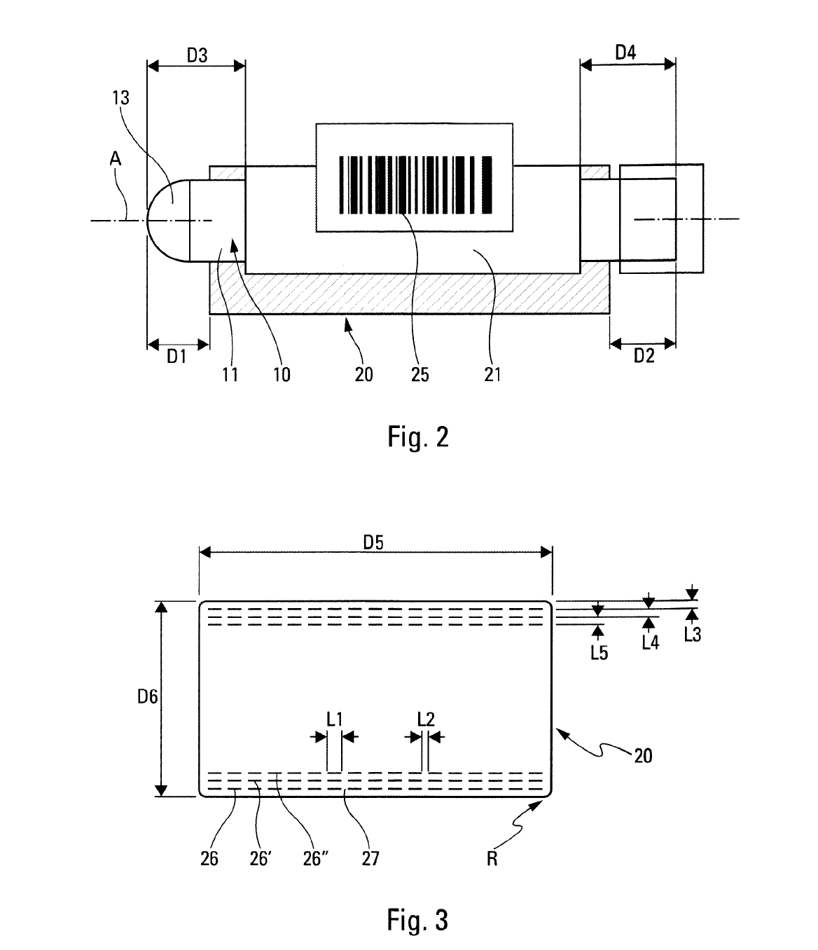

FIG. 2 is a schematic plan view of a standard test tube provided with a self-adhesive label, and

FIG. 3 is a schematic plan view of a self-adhesive label according to an advantageous embodiment of the present invention.

In the description, the terms “longitudinal” and “transverse” refer to the longitudinal axis A of the tube shown in FIG. 2.

FIG. 2 shows a conventional test tube 10 and a suitable self-adhesive label 20.

In a known manner, the tube 10 is formed by a cylinder 11, having on one end an opening 12, and closed on the other end by an end portion 13. Said end portion 13 is preferably rounded, advantageously hemispherical. The opening 12 is closed by a cap 15 which may be of any suitable type, and which is therefore represented here in only a very schematic way. The tube 10 may be made of glass, notably Pyrex, or of suitable plastic material, notably polypropylene.

The self-adhesive label 20 is affixed to said cylinder 11. It is generally rectangular in shape, having suitable bonding means on the inner surface thereof and identification means 25 on the upper surface thereof, such as a bar code or any suitable indicator for identifying said test tube 10 and/or the contents thereof. Typically, the label 20 has an indication area 21 of slightly smaller dimensions than the dimensions of the label and which receives said identification means 25. The label 20 is generally made of paper or the like.

There are several standard sizes for test tubes and therefore also for the associated labels.

Typically, the volume of the test tubes 10 varies from 1.8 to 10 ml, and their length varies from 66 to 100 mm.

Concerning the label 20, tube manufacturers, notably Becton Dickinson and Sarstedt, make the following recommendations:

the length D1 between the edge of the label 20 and the end of the end portion 13 of the tube 10 should be at least 9 mm, advantageously at least 15 mm;

the length D2 between the edge of the label 20 and the opening 12 of the tube 10 should be at least 10 mm;

the length D3 between the edge of the indication area 21 and the end of the end portion 13 should be at least 20 mm;

the length D4 between the edge of the indication area 21 and the opening 12 should be at least 14 mm;

the width of the indication area 21 should be at least 5 mm less than the circumference of the tube 10.

By applying these recommendations, the following are obtained:

for a tube 10 of 100 mm in length, a label 20 of 75 mm in length and an indication area 21 of 66 mm in length;

for a 10 tube of 75 mm in length, a label 20 of 50 mm in length and an indication area 21 of 41 mm in length;

for a 10 tube of 66 mm in length, a label 20 of 41 mm in length and an indication area 21 of 32 mm in length.

Of course, these values are not limiting, and the lengths D1 to D4 may be different.

As a result, there are many labels of different sizes on the market. For example, Citilab sells labels with a length D5=44 mm and a width D6=25 mm; Sarstedt sells labels with a length D5=40 mm and a width D6=26 mm; and Roche sells labels with a length D5=35 mm and a width D6=18 mm.

In general, self-adhesive labels for laboratory test tubes preferably have a length D5 comprised between 35 and 44 mm and a width D6 comprised between 18 and 29 mm. Here too, however, the lengths D5 and D6 may be different.

FIG. 3 illustrates a label 20 made according to an advantageous embodiment of the invention.

Said label 20 is rectangular and advantageously has a length D5=44 mm, a width D6=25 mm, and curved corners with a radius of curvature R=1 mm.

According to the invention, the label 20 has on each longitudinal edge intermittent cuts 26 extending longitudinally along said longitudinal edge. These intermittent cuts 26, which pass through the thickness of the label, prevent, after the label 20 is affixed to the tube 10, the detachment of said longitudinal edges, even after a certain period of storage. Indeed, these intermittent cuts 26 break up the force generated in the curved label after affixing, and which seeks to return the label to its flat, unbent state. This phenomenon generates a detachment of the labels affixed to the tubes after a period of storage. The intermittent cuts 26 of the invention prevent and at the very least greatly delay this detachment of the longitudinal edges of the labels, thus avoiding the above-mentioned risks associated with such detachment, notably with laboratory test tubes.

Preferably, said intermittent cuts 26 are evenly distributed and extend substantially over the totality of each longitudinal edge of the label 20.

Advantageously, said intermittent cuts 26 are made in the form of slits separated by bridges of material 27. The length L1 of the slits 26 is advantageously comprised between 1 and 3 mm, preferentially between 1.5 and 2.5 mm, notably 1.9 mm. The length L2 of the bridges of material 27 is advantageously comprised between 0.1 and 2 mm, preferentially between 0.5 and 0.7 mm, notably 0.6 mm.

Advantageously, each longitudinal edge of the label 20 comprises several series of intermittent cuts 26, 26′, 26″ spaced transversely. In the example in FIG. 3, there are three series of intermittent cuts 26, 26′, 26″. Advantageously, these series of intermittent cuts 26, 26′, 26″ are evenly spaced in the transverse direction. Thus, in the example in FIG. 3, the length L3 between the longitudinal edge of the label 20 and the first series of intermittent cuts 26 is 1 mm, the length L4 between the first series of intermittent cuts 26 and the second series of intermittent cuts 26′ is 1 mm, and the length L5 between the second series of intermittent cuts 26′ and the third series of intermittent cuts 26″ is 1 mm.

Of course, the lengths L1 to L5 may be different. In particular, the gaps L3, L4 and L5 between the longitudinal edges and the series of intermittent cuts 26, 26′, 26″ are not necessarily identical.

In addition, the intermittent cuts 26, 26′, 26″ may be made in a different way, for example holes rather than slits. Moreover, the intermittent cuts are not necessarily made evenly, either in the longitudinal direction or in the transverse direction.

Advantageously, the intermittent cuts 26 are made by suitable means, such as blades, punches or knives. Said cuts can be made during the manufacture of the label, or during the printing of the indication means 25 on the label.

The invention applies more particularly to laboratory test tubes. It may however generally apply to any self-adhesive label intended to be affixed to a cylindrical tube.

The present invention has been described with reference to an advantageous embodiment, but it is understood that a skilled person may make any modifications thereto, without going beyond the scope of the present invention as defined by the attached claims.

1. Self-adhesive label (20) for a tube (10), said label (20) being substantially rectangular and comprising bonding means on the inner surface thereof and identification means (25) on the upper surface thereof, characterized in that said label (20) comprises on each longitudinal edge intermittent cuts (26) extending longitudinally along said longitudinal edges, wherein each longitudinal edge of the label comprises several series of intermittent cuts spaced transversely.

2. Label according to claim 1, wherein said intermittent cuts (26) are evenly distributed and extend substantially over the totality of each longitudinal edge of the label (20).

3. Label according to claim 1, wherein said intermittent cuts (26) are made in the form of slits separated by bridges of material (27).

4. Label according to claim 3, wherein the length (L1) of the slits (26) is comprised between 1 and 3 mm, advantageously between 1.5 and 2.5 mm, and the length (L2) of the bridges of material (27) is comprised between 0.1 and 1 mm, advantageously between 0.5 and 0.7 mm.

5. Label according to claim 4, wherein the length (L1) of the slits (26) is 1.9 mm and the length (L2) of the bridges of material (27) is 0.6 mm.

6. (canceled)

7. Label according to claim 1, wherein said series of intermittent cuts (26, 26′, 26″) are evenly spaced in the transverse direction.

8. Label according to claim 7, wherein the length (L3) between the longitudinal edge of the label (20) and the first series of intermittent cuts (26) is 1 mm, the length (L4) between the first series of intermittent cuts (26) and the second series of intermittent cuts (26′) is 1 mm, and the length (L5) between the second series of intermittent cuts (26′) and the third series of intermittent cuts (26″) is 1 mm.

9. Label according to claim 1, wherein the length (D5) of the label (20) is comprised between 35 and 44 mm and the width (D6) of the label (20) is comprised between 18 and 29 mm.

10. Label according to claim 9, wherein said length (D5) is 44 mm, said width (D6) is 25 mm, and the corners of the label (20) are curved with a radius of curvature R of 1 mm.

11. Tube (10) comprising a cylinder (11) provided on one end with an opening (12) and closed on the other end by an end portion (13), preferably rounded, characterized in that a label (20) made according to claim 1 is affixed to said cylinder (11).

12. Tube according to claim 11, wherein said tube (10) is a laboratory test tube.

13. Tube according to claim 11, wherein the volume of the tube (10) is comprised between 1.8 and 10 ml, and the length of the tube (10) is comprised between 66 and 100 mm.
